(19) United States
(12) Patent Application Publication
(10) Pub. No.: US 2009/0171719 A1
(43) Pub. Date: Jul. 2, 2009

(54) Interactive system and method for displaying support and support-related processes

(75) Inventor: Paul Connington, Preston (GB)

Correspondence Address: BUCHANAN, INGERSOLL & ROONEY PC, POST OFFICE BOX 1404, ALEXANDRIA, VA, 22313-1404, US

(73) Assignee: BAE SYSTEMS plc, London (GB)

(21) Appl. No.: 12/003,643

(22) Filed: Dec. 28, 2007

(51) Int. Cl. G06Q 10/00

(52) U.S. Cl. 705/7

(57) ABSTRACT

An interactive system for displaying support and support-related processes includes a memory arrangement, a processor, a display and an interactive user interface. The memory arrangement is configured to store support and support-related processes across multiple entities for a lifecycle of a system and/or project. The processor is configured to generate relationships between the support and support-related processes. The system also includes a display and an interactive graphical user interface displayable on the display, wherein the interactive graphical user interface illustrates the support and support-related processes across the lifecycle of the system and/or project in a hierarchical structure.

### BACKGROUND

Business modeling encompasses a broad range of informal and formal models that can be implemented in software and/or hardware, and used to represent various aspects of business, such as operational processes, organizational structures, and financial forecasts.

### SUMMARY

An exemplary embodiment is an interactive computer system for displaying support and support-related processes. The system includes a memory arrangement for storing support and support-related processes across multiple entities for a lifecycle of a system and/or project. A processor is configured to generate relationships between the support and support-related processes. The system also includes a display and an interactive graphical user interface displayable on the display, wherein the interactive graphical user interface illustrates the support and support-related processes across the lifecycle of the system and/or project in a hierarchical structure.

An exemplary method is disclosed for displaying support and support-related processes for a system and/or project lifecycle. The method includes creating a virtual model from concept to disposal of a system and/or project using a business modeling software application, and inputting the virtual model into an application that includes an interactive graphical user interface that displays support and support-related processes across multiple entities for a lifecycle of the system and/or project in a hierarchical structure.

A computer readable medium is disclosed that contains a computer program for displaying support and support-related processes for a system and/or project lifecycle. The computer program includes executable instructions for: displaying support and support-related processes across multiple entities in an interactive graphical user interface for a lifecycle of a system and/or project in a hierarchical structure, and decomposing at least some of the support and support-related processes into one or more sub processes.

### BRIEF DESCRIPTION OF THE DRAWINGS

In the following, exemplary embodiments will be explained in greater detail in reference to drawings, wherein:

FIG. 1 illustrates a system for displaying support and support-related processes across a lifecycle in accordance with an exemplary embodiment;

FIG. 2 illustrates an interactive user interface screen in accordance with an exemplary embodiment;

FIG. 3 illustrates a process map worksheet displaying a hierarchical structure of the system in accordance with an exemplary embodiment;

FIG. 4 illustrates an indented process map worksheet displaying a hierarchical structure of the system in accordance with an exemplary embodiment;

FIG. 5 illustrates a process model page in accordance with an exemplary embodiment;

FIG. 6 illustrates a sub process page in accordance with an exemplary embodiment; and

FIG. 7 is a flow diagram that illustrates a method of displaying support and support-related processes for a system and/or project lifecycle in accordance with an exemplary embodiment.

### DETAILED DESCRIPTION

Exemplary embodiments disclosed herein are directed to a computer system to map and/or graphically display support-related processes, across the lifecycle of a system and/or project, in a hierarchical structure.

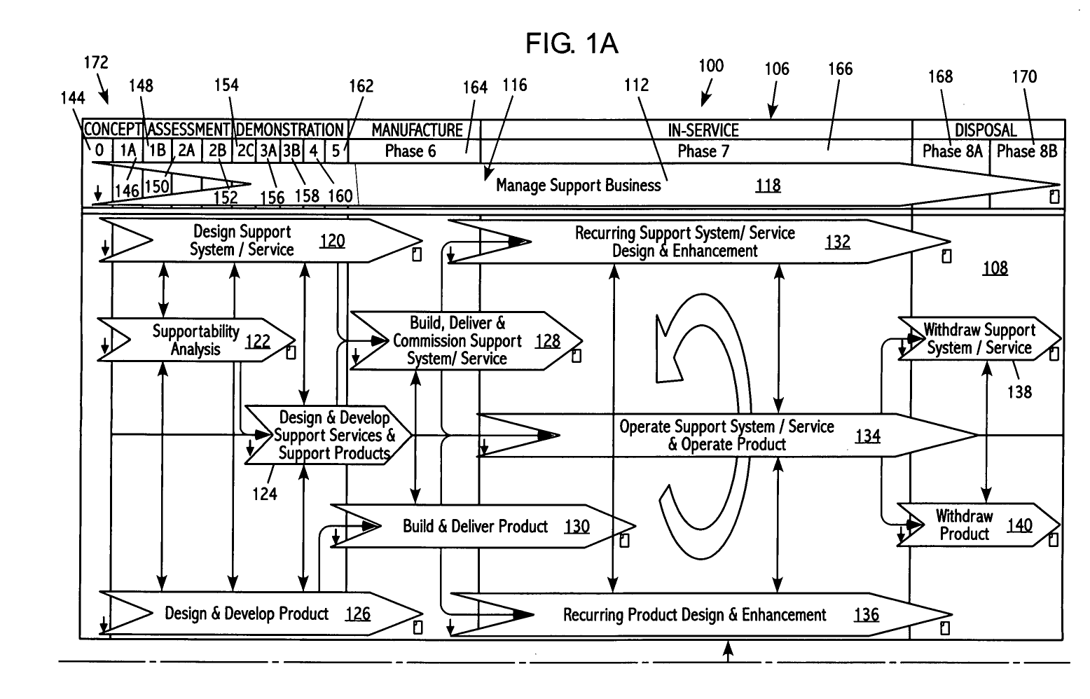

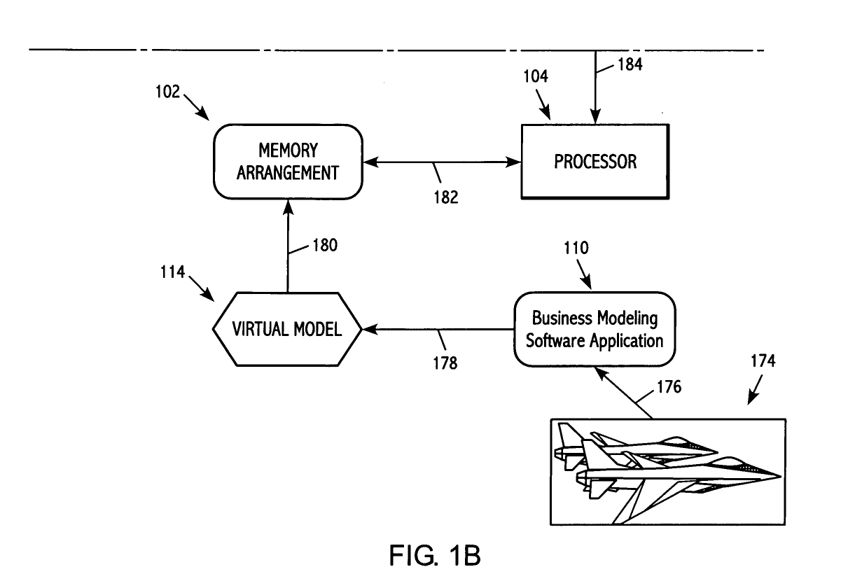

FIG. 1 illustrates an exemplary system 100 for displaying support and support-related processes in accordance with an exemplary embodiment. The system 100 includes a memory arrangement 102, a processor 104, a display 106, and an interactive graphical user interface (or GUI) 108.

The memory arrangement 102 is configured to store support and support-related processes 112 across multiple entities for a lifecycle 172 of a system and/or project represented as a product 174, wherein a “lifecycle” as referenced herein can encompass a system or project evolution from conception to termination and/or disposal (or any designated portion), including any or all support and support related processes across multiple entities (e.g., multiple business units, vendors, joint partners and so forth). A project can include one or more products which may or may not bear any specified relationship to one another including, as desired, any support or support related products and/or services). In accordance with an exemplary embodiment, the business process modeling software tool 110 produces a virtual model 114, which identifies the processes necessary to engineer and/or design the system and/or product 174. In accordance with an exemplary embodiment, the business process modeling software tool or application 110 receives input 176 on the desired system or product 174 from the customer and/or user. Based on the input 176 from the customer or user, the business process modeling software tool or application 110 creates 178 a virtual model 114 of the entire business, covering all phases of the lifecycle 172, from concept to disposal, and during the in-service phase, from fox-hole to factory. In accordance with an exemplary embodiment, the lifecycle 172 includes concept, assessment, demonstration, manufacture, in-service and disposal.

In accordance with an embodiment, the business modeling software tool 110 is database driven, including a library of best-practice processes for the system and/or product 170. The tool can be any commercially available business modeling tool suitably programmed in a manner as described herein to generate a desired file set as a virtual model and/or other desired data. An exemplary tool is the IFS Business Modeler tool available from IFS, a worldwide company and/or ARIS Platform available from IDS Scheer located in Germany. The tools can be used, as disclosed herein to create data structures and data relationships in a computer memory that encompasses all phases of the lifecycle 172. In FIG. 1, the virtual model 114 and the data derived from the business process modeling software tool 110 are integrated 180 into the memory arrangement 102, which through the processor 104 links all of the support and support-related processes 112 in a layer or hierarchical model.

The processor 104 is configured to generate 182 relationships between the support and support-related processes 112. The processor 104 sends 184 the support and support-related processes 112 to the display 106 so that the relationships between the support and support-related processes 112 can be displayed on an interactive graphical user interface 108, wherein the interactive graphical user interface 108 illustrates the support and support-related processes 112 across the lifecycle 172 of the system and/or product 174 in a hierarchical structure. The graphical user interface 108 also displays the relationships between the support and support-related processes 112. In accordance with an exemplary embodiment, the particular process model can include an interactive graphical view, depicting one or more support or support-related processes 112, and showing the relationship between processes 112, inputs, outputs, constraints and other influences.

In accordance with an exemplary embodiment, the system 100 provides an interactive graphical overview of the relationship from concept to disposal (i.e., lifecycle) of the support and support-related processes 112 across multiple entities for the lifecycle 172 of the system and/or product 174. The system 100 is configured to provide guidance to project personnel to support the development of project specific processes and appropriate support program management documentation. The system 100 also provides a source of reference to assist project personnel to understand the support and support-related process and/or activities outside of their experience and can be used as a yardstick to measure progress of each of the specific support and support-related processes 112.

For example, in an exemplary embodiment, the system 100 can be used in the lifecycle 172 of a system and/or product 174, which is a repeatable military system and/or military product, including the delivery and support of advanced defense and aerospace systems in the air, on land and/or at sea, including contributions from both civilian and military entities. In another exemplary embodiment, the system 100 can be used by a service and/or entity operated to support the customer and/or user of the system 100.

In accordance with an exemplary embodiment, the support and support-related processes 112 can include one or more of the following top level processes 116: Manage Support Business 118; Design Support System/Service 120; Supportability Analysis 122; Design & Develop Support Services & Support Products 124; Design & Develop Product 126; Build, Deliver & Commission Support System/Service 128; Build & Deliver Product 130; Recurring Support System/Service Design & Enhancement 132; Operate Support System/Service & Operate Product 134; Recurring Product Design & Enhancement 136; Withdraw Support System/Services 138; and Withdraw Support 140.

The Manage Support Business process 118 addresses the support program activities from initial contract with the customer, through contract negotiations, contract execution to closure.

The Design Support System/Service process 120 addresses the high level design of the support system/service. The process 120 analyses the individual results of supportability analysis to produce a cohesive support solution design that fulfills the contract requirements in the most cost-effective manner. The design of the support system/service process 120 also includes the management structure to manage the introduction and implementation of the support system/service.

The Supportability Analysis process 122 is a broad analysis that combines all support aspects with the aim of integrating with and influencing the emerging design of the product (and/or system). The supportability analysis process also defines the product's support requirements upon the design of the support system/service. The intention is to ensure that the design is supportable when it enters the in-service phase of the lifecycle.

The Design & Develop Support Services & Support Product process 124 addresses the design, development, and testing of the support services and support products to meet the requirements identified during the support system/service design and supportability analysis processes.

The Design & Develop Product process 126 addresses the activities required to design, develop, and enhance the product. The activities include the support process flow to illustrate the relationship to the product engineering design activities.

The Build & Deliver Product process 128 addresses the build and delivery of prototype and production products from the configured design. The product activities can include illustrating the close relationships to the various support activities.

The Recurring Support System/Service Design & Enhancement process 132 addresses the analysis conducted to determine the ongoing effectiveness of the support solution and the support-related performance of the equipment (e.g., equipment reliability). The process 132 also includes proposed actions to continuously improve the support system.

The Operate Support System/Service and Operate Product process 134 addresses the ongoing operation with respect to activities associated with training, the use of the product, the maintenance of the product and training systems, the operation of the supply chain and management of the operations and support of the fleet. The process 134 also includes the actions to monitor and provide feedback on the support system and product effectiveness.

The Recurring Product Design & Enhancement process 136 maintains the design of the product and modifications to the design though the life of the product. The activities include the support process flow to illustrate the relationship to the product engineering design activities.

The Withdraw Support System/Service process 138 addresses the disposal, recycle, storage or sale of the equipment, sub-systems and resource items within the support system, which can also include reactivation.

The Withdraw Product process 140 illustrates the relationship to product engineering activities associated with product/platform withdrawal.

In accordance with another exemplary embodiment, the Design Support System/Service process 120, the Design & Develop Product process 126, the Recurring Support System/Service Design & Enhancement process 132, and the Recurring Product Design & Enhancement process 136 can be merged into a single top level process 116.

In accordance with an exemplary embodiment, the system 100 is configured to provide a generic integration framework template for multi-functional through life support processes to share best practice and knowledge, and promote synergy across a company. In addition, the system 100 provides a template for through life solutions to reduce solution design and development lead times, reduce risks and costs, and improve performance and solution effectiveness for customers and/or users.

In an exemplary embodiment, the system 100 utilizes a lifecycle or Lifecycle Management (LCM) phase process 142, which includes eight (8) separate phases and/or sub-phases. The eight (8) phases and/or sub-phases include: Phase 0—Opportunity 144; Phase 1A—Analyze Market 146; Phase 1B—Bid/No Bid 148; Phase 2a—Bid Process 150; Phase 2B—Contract Acceptance 152; Phase 2C—Project Mobilization 154; Phase 3A—Preliminary Design 156; Phase 3B—Detailed Design 158; Phase 4—Development & Integration 160; Phase 5—System Qualification 162; Phase 6—Production & Delivery 164; Phase 7—Support & Servicing 166; Phase 8A—Withdrawal 168; and Phase 8B—Disposal 170.

For example, in an exemplary embodiment, the system 100 provides the support and support-related processes 112 across the lifecycle 172 from concept to disposal for the management activities required to design, develop, produce, deliver, operate and withdraw support products and support services for a support solution. In addition, the system 100 can graphically display or depict the product activities that interface with the support activities to design, build, deliver, operate and withdraw a system or product 174, including the interaction between management, support and product activities.

The system 100 is designed so that that any individual project can be mapped to the detailed processes and such that tailored versions of the system can be developed for each project. For example, activities, which span all functional areas regardless of business units or organizations, and without regard to the various levels of complexity can be mapped or displayed in an interactive graphical user interface. The system 100 also provides an interactive model from concept (cradle) to disposal (grave) of the support and support-related processes, which includes identifying support activities, support-related product activities, relationships between activities, boundaries of responsibility, and process dependencies. For example, in accordance with an exemplary embodiment, the system 100 provides information to logistics & information systems by identifying process application legacy requirements, information flow between processes, and process/information management requirements.

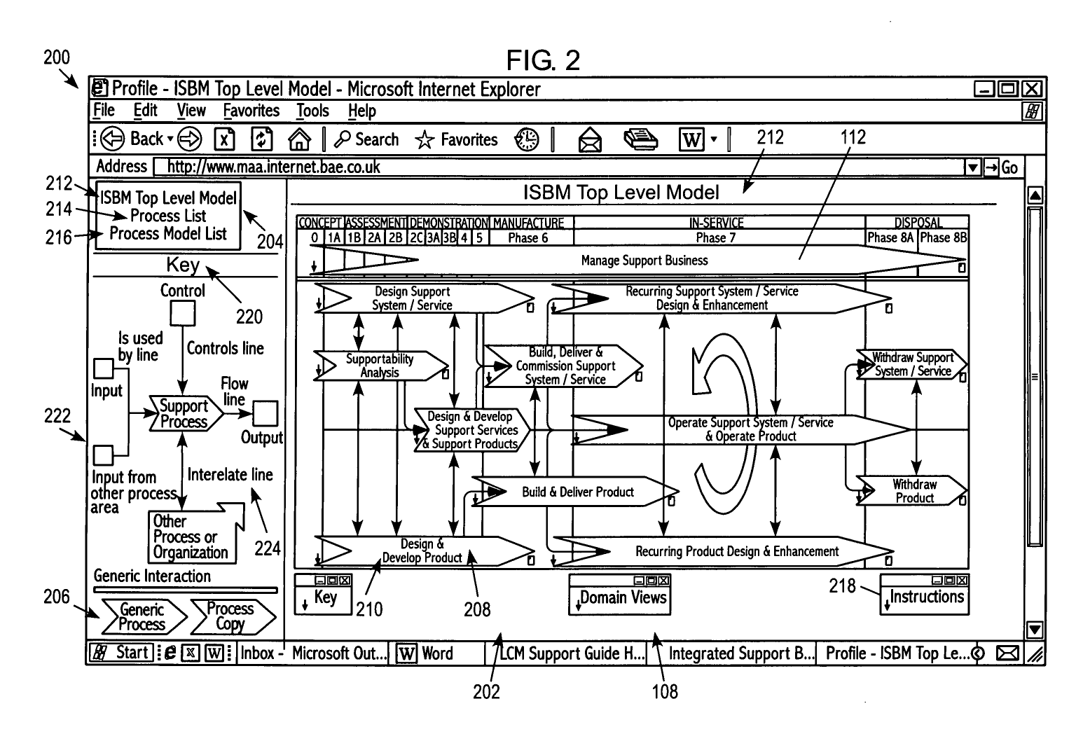

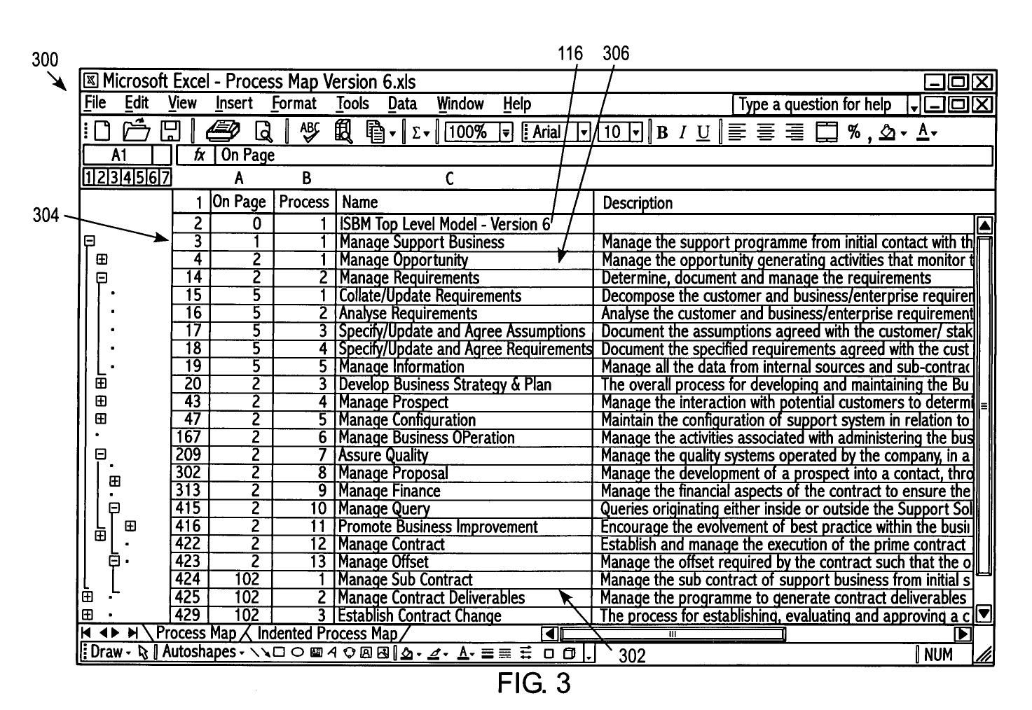

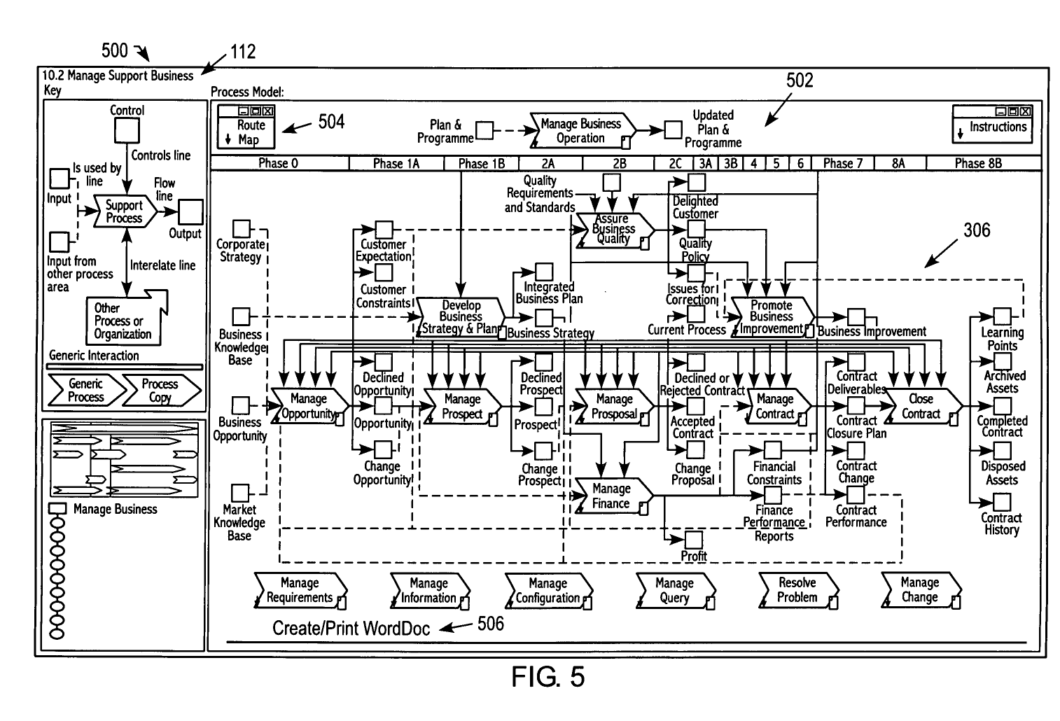

The system 100 can be presented in three formats: a web based interactive model 200 (FIG. 2); a spreadsheet hierarchical model 300 (FIG. 3); and a documented version or model 500 (FIG. 5). The interactive model 200 is a version of the system 100, in HTML format (i.e., hyperlinked HTML pages) or other suitable format, which allows a user to navigate through the interactive graphical user interface and/or process models. The hierarchical model 300 is a version of the system 100, in spreadsheet format, which allows a user to navigate through the system's structure in tabular form and make use of the system's structure. The documented version or model 500 is the full version, preferably in a file format or portable document file format (PDF) created by Adobe®, which presents each process model in association with the attribute data compiled against each support or support-related process and/or sub process.

In accordance with an exemplary embodiment, the system 100 and supporting information can be accessed through a dedicated Intranet site and/or a secure Internet site. Alternatively, the system 100 can be delivered to a user via a compact disk (CD) or other storage medium.

FIG. 2 illustrates an interactive user interface screen 200 in accordance with an exemplary embodiment. The interactive user interface screen 200 can include (e.g., consist of) three windows as illustrated in FIG. 2, which includes a main window 202, a function window 204, and a message window 206.

The main window 202 provides an interactive graphical user interface 108 of the support and support-related processes 112 illustrating the flow of business objects through a number of sub processes 306. In accordance with an exemplary embodiment, a description of the sub process 306 may be displayed by positioning (or hovering) a pointing device (or mouse pointer) over the support or support-related process symbol 210. In an exemplary embodiment, where a support or support-related process 112 decomposes (indicated by an embedded down arrow) the lower level or sub process 306 may be displayed to by clicking the left mouse button over the support or support-related process 112, 306. The main window 202 also provides buttons to bring up instructions 218, a route map 504 (FIG. 5) in the message window 206 and a link 506 (FIG. 5) to a Microsoft Word® document or other suitable document program, which contains graphical images.

The function window 204 provides the user the ability to quickly navigate or return to the systems' top level model 212, display a list or index 216 of process models, or display a full list or index 214 of support or support-related processes 112.

The message window 206 displays the model key 220, model instructions 222, a route map 224 for a selected or current model, and the list 216 of process models or the full list or index 214 of the support and support-related processes 112, 306. In an exemplary embodiment, displaying the process list 214 in the message window 206 is performed by selecting or clicking on the list or index of process models 216 or the process list 214 in the function window 204.

FIG. 3 illustrates a process map worksheet 300 displaying a hierarchical model 302 of the system 100 in accordance with an exemplary embodiment. The hierarchy model 302 consists of a process map 304 showing the system's hierarchy. The process map worksheet 300 displays the hierarchical structure of the system 100 in vertical tabular form using a grouping function such as Excel® Grouping to allow the level of decomposition to be controlled by the user. The hierarchical structure of the system 100 includes top level processes 116 and sub processes 306. In accordance with an exemplary embodiment, the hierarchical model 302 version of the system 100 can be accessed via a company Intranet site or a secure Internet site.

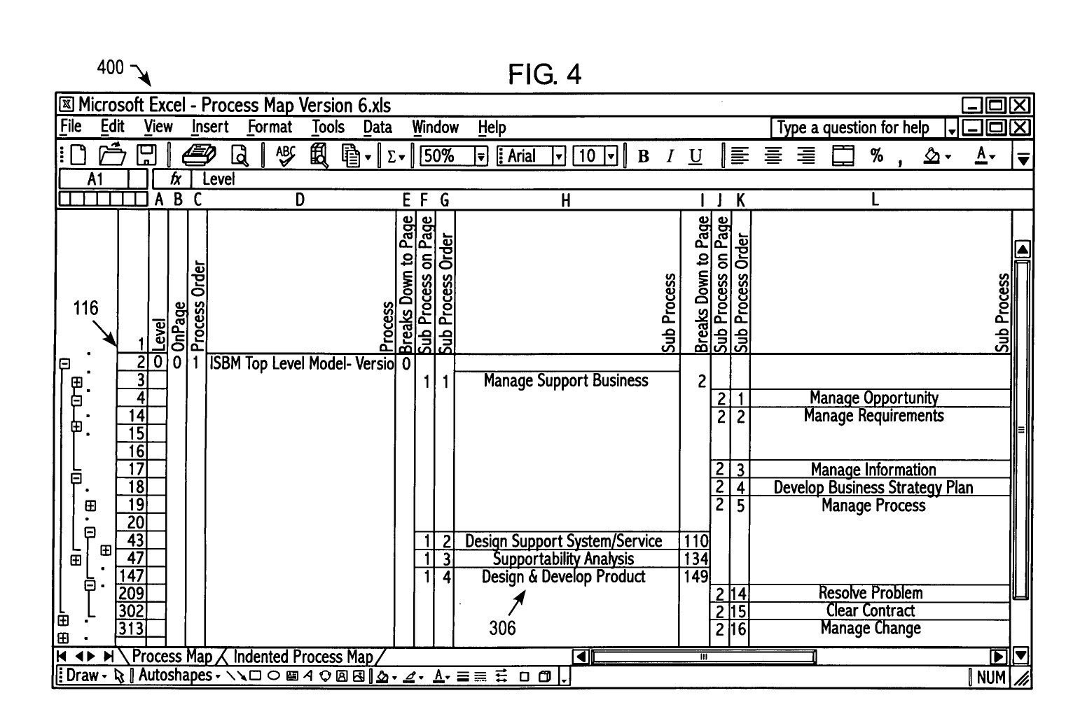

FIG. 4 illustrates an indented process map worksheet 400 displaying a hierarchical structure of the system 100 in accordance with another exemplary embodiment. The indented process map worksheet 400 displays the hierarchical structure of the system 100 in horizontal tabular form. As shown in FIG. 4, the top level processes 116 are shown on a left hand side of the worksheet 400 with the sub processes 306 to the right thereof. In accordance with an exemplary embodiment, the level of decomposition of the sub processes 306 can be controlled by the customer and/or user.

For example, in an exemplary embodiment, the level of decomposition displayed may be controlled by the user on either worksheet 300, 400 by selecting the <+>, <−> and <level number> buttons on the left of the worksheets 300, 400. In accordance with an exemplary embodiment, a ‘read only’ spreadsheet may be saved by the user to provide an amendable copy for marking process applicability and process responsibility, and mapping process alignment to other models.

In accordance with another exemplary embodiment, a documented version or model 500 of the system 100 provides the configuration controlled record of a particular version of the system 100. The documented version 500 of the system 100 can be accessed through an Intranet site, a secure Internet site or via a compact disk or other storage medium.

FIG. 5 illustrates a process model page 502 in accordance with an exemplary embodiment. The process model page 502 as shown in FIG. 5 is a graphical view, depicting one or more top level processes 116 or sub processes 306, which shows the relationships between processes, inputs, outputs, constraints and any other influences. In accordance with an exemplary embodiment, a support and support-related process 112 or sub process 306 is an activity, which may have lower levels of embedded detail, which acts on inputs to produce a defined output or outputs.

In accordance with an exemplary embodiment, the content of a process model page 502 can be restricted to that viewable on a single graphical user interface screen and/or page. The process model page 502 presents a graphical representation or depiction of a particular support or support-related process 112, including an indication of a relative position of the particular process model or process 112 within the overall system 100 and providing a description of the particular support or support-related process 112.

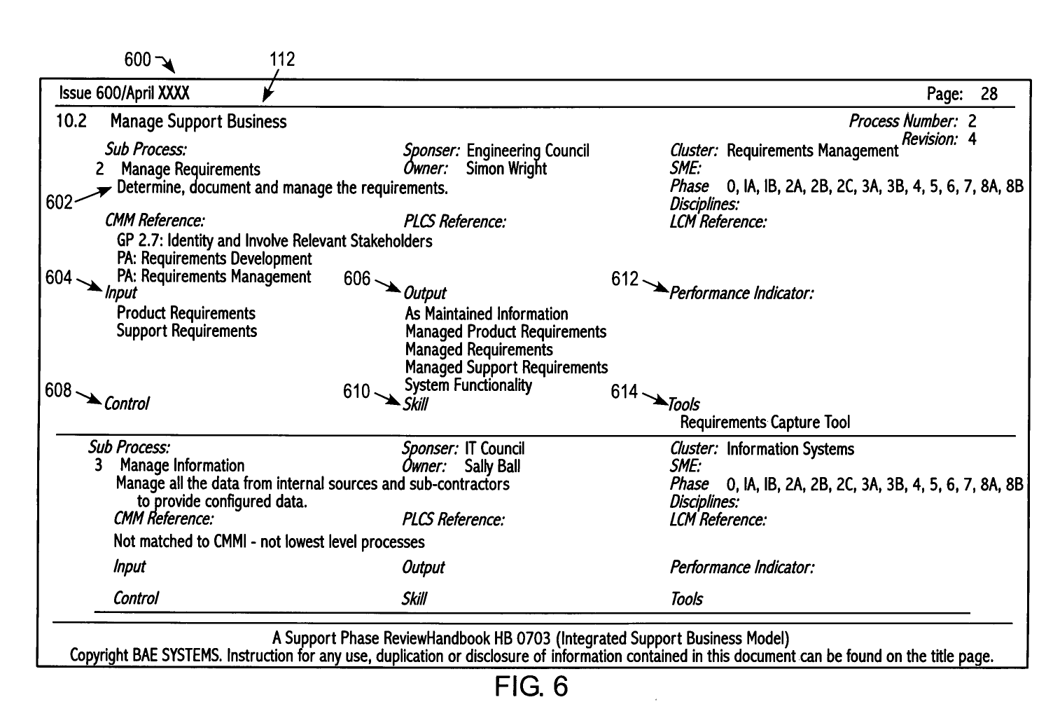

FIG. 6 illustrates a sub process page 600 in accordance with an exemplary embodiment. The sub process page 600 provides a description 602 of each sub process 306 and associated information such as inputs 604 to the sub process 306, outputs 606 from the sub process 306, controls 608 for the sub process 306, skills 610 required to carry out the process, performance indicators 612, and tools 614. Additional information can also include the Lifecycle phase in which the sub process is carried out; the disciplines performing the activity or process; reference to the appropriate LCM (Lifecycle Management) checklist or phase; references to a PLCS (Product Lifecycle Support) activity model, if applicable; reference to a CMMI (Capability Maturity Model Integration) process, if applicable; and process model number, if the sub process is process model.

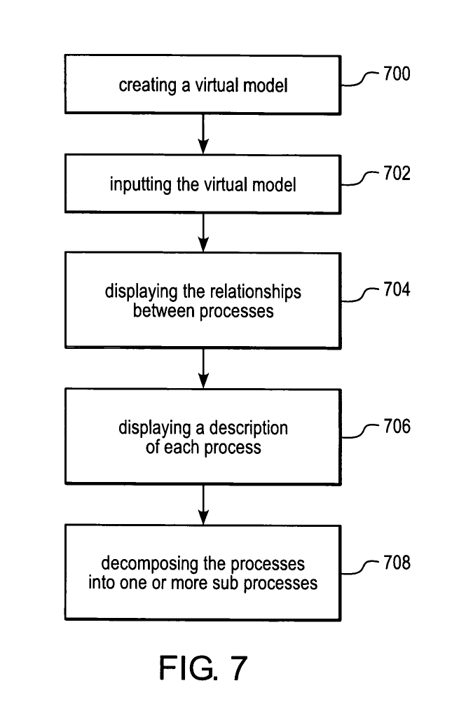

FIG. 7 is a flow diagram that illustrates a method of displaying support and support-related processes for a system and/or project lifecycle in accordance with an exemplary embodiment.

In step 700, a virtual model of a system and/or product from concept to disposal is created using a business modeling software application. In a step 702, the virtual model is then inputted into an application that includes an interactive graphical user interface that displays support and support-related processes across multiple entities for a lifecycle of the system and/or product in a hierarchical structure. The interactive graphical user interface displays the relationships between the support and support-related processes (step 704). In a step 706, a description of each support or support-related process is displayed by positioning a pointing device over the support or support-related process. In a step 708, the support and support-related processes are decomposed into one or more sub processes by positioning a pointing device over the support and support-related process and/or the one or more sub processes, and activating a control on the pointing device while the pointer is positioned over the support and support-related processes and/or the one or more sub processes.

In an exemplary embodiment, a computer program which implements all or parts of the processing described herein through the use of a system 100 as illustrated in FIGS. 1-7 can take the form of a computer program product residing on a computer usable or computer readable medium. Such a computer program can be an entire application to perform all of the tasks necessary to carry out the invention, or it can be a macro or plug-in which works with an existing general purpose application such as a spreadsheet program. Note that the “medium” may also be a stream of information being retrieved when a processing platform or execution system downloads the computer program instructions through the Internet or any other type of network. Computer program instructions, which implement the invention, can reside on or in any medium that can contain, store, communicate, propagate or transport the program for use by or in connection with any instruction execution system, apparatus, or device. Such a medium may be, for example, but is not limited to, an electronic, magnetic, optical, electromagnetic, or semiconductor system, apparatus, device, or network. Note that the computer usable or computer readable medium could even be paper or another suitable medium upon which the program is printed, as the program can then be electronically captured from the paper and then compiled, interpreted, or otherwise processed in a suitable manner.

While the invention has been described with reference to specific embodiments, this description is merely representative of the invention and is not to be construed as limiting the invention. Various modifications and applications may occur to those skilled in the art without departing from the true spirit and scope of the invention as defined by the appended claims.

What is claimed is:

1. An interactive system for displaying support and support-related processes, the system comprising:
a memory arrangement for storing support and support-related processes across multiple entities for a lifecycle of a system and/or project;
a processor configured to generate relationships between the support and support-related processes;
a display; and
an interactive graphical user interface displayable on the display, wherein the interactive graphical user interface illustrates the support and support-related processes across the lifecycle of the system and/or project in a hierarchical structure.

2. The system of claim 1, wherein the interactive graphical user interface displays the relationships between the support and support-related processes.

3. The system of claim 1, wherein at least some of the support and support-related processes decompose into sub processes.

4. The system of claim 1, wherein the support and support-related processes include a process page, which provides a description of each support and support-related process and associated information including inputs, outputs, controls and other influences.

5. The system of claim 1, wherein the interactive graphical user interface includes:
a main window, which provides an interactive user interface, which is representative of the support or support-related processes and illustrating a flow of business objects through the support or support-related processes;
a message window, which displays one or more of a model object key, a route map for a selected support or support-related process, an interactive process map index, and a specific process index; and
a function window, which provides access to navigate to a top level model, the interactive process map and/or the specific process index.

6. The system of claim 1, wherein a description of each support or support-related processes is displayed by positioning a pointing device over the support or support-related processes.

7. The system of claim 1, wherein the system and/or project is a repeatable military system or military product.

8. The system of claim 1, wherein the lifecycle includes concept, assessment, demonstration, manufacture, in-service and disposal.

9. The system of claim 1, wherein the multiple entities for the lifecycle of the system or project include contributions from both civilian and military entities.

10. The system of claim 1, comprising:
a business modeling software application, which receives input to create a virtual model from concept to disposal of the system or project.

11. The system of claim 1, wherein the support and support-related processes include one or more of the following top level processes: Manage Support Business; Design Support System/Service; Supportability Analysis; Design & Develop Support Services & Support Products; Design & Develop Product; Build, Deliver & Commission Support System/Service; Build & Deliver Product; Recurring Support System/Service Design & Enhancement; Operate Support System/Service & Operate Product; Recurring Product Design & Enhancement; Withdraw Support System/Services; and Withdraw Support.

12. The system of claim 1, wherein the interactive graphical user interface is an hierarchy model comprising:
at least two worksheets, which display the hierarchical structure of the support and support-related processes in a vertical tabular form.

13. The system of claim 1, comprising:
a documented version of each of the interactive graphical user interface screens.

14. A method of displaying support and support-related processes for a system and/or project lifecycle, the method comprising:
creating a virtual model of a system and/or project from concept to disposal using a business modeling software application; and
inputting the virtual model into an application that includes an interactive graphical user interface that displays support and support-related processes across multiple entities for a lifecycle of the system and/or project in a hierarchical structure.

15. The method of claim 14, wherein the interactive graphical user interface displays the relationships between the support and support-related processes.

16. The method of claim 14, comprising:
displaying a description of each support or support-related process by positioning a pointing device over the support or support-related process.

17. The method of claim 14, comprising:
decomposing the support and support-related processes into one or more sub processes by positioning a pointing device over the support and support-related process and/or the one or more sub processes and activating a control on the pointing device while the pointer is positioned over the support and support-related processes and/or the one or more sub processes.

18. A computer readable medium containing a computer program for displaying support and support-related processes for a system and/or project lifecycle, wherein the computer program comprises executable instructions for:
displaying support and support-related processes across multiple entities in an interactive graphical user interface for a lifecycle of a system and/or project in a hierarchical structure; and
decomposing at least some of the support and support-related processes into one or more sub processes.

19. The computer readable medium of claim 18, wherein the computer program comprises executable instructions for:
displaying the relationships between the support and support-related processes and/or the one or more sub processes.

20. The computer readable medium of claim 18, wherein the computer program comprises executable instructions for:
displaying a description of each support or support-related processes and/or the one or more sub processes by positioning a pointing device over the support or support-related processes and/or the one or more sub processes.

21. The computer readable medium of claim 18, wherein the computer program comprises executable instructions for:
decomposing the support and support-related processes into one or more sub processes by positioning a pointing device over the support or support-related process and/or the one or more sub process, and activating a control on the pointing device while the pointer is positioned over the support and support-related processes and/or the one or more sub processes.
